(19) United States
(12) Patent Application Publication
(10) Pub. No.: US 2020/0252267 A1
(43) Pub. Date: Aug. 6, 2020

(54) PRIORITY-BASED DECISION MAKING FOR NETWORK SWITCH STATE CHANGE

(71) Applicant: HEWLETT PACKARD ENTERPRISE DEVELOPMENT LP, Houston, TX (US)

(72) Inventors: Sharath Srikanth Chellappa, Bangalore (IN); Vikas Kumar Pareek, Bangalore (IN); Yashavantha Nagaraju Naguvanahalli, Bangalore (IN); Dhanesh Kumar Shanmuga Sundaram, Bangalore (IN)

(21) Appl. No.: 16/266,634

(22) Filed: Feb. 4, 2019

(51) Int. Cl. H04L 12/24

(52) U.S. Cl. CPC H04L 41/082; H04L 41/04; H04L 41/0893; H04L 41/0266

(57) ABSTRACT

A network switch may determine a prioritized set of state parameters for the network switch. The network switch may receiving an indication of a command and may, in response, determine whether the command is currently performable based at least in part on comparing a set of current state information of the network switch with the prioritized set of state parameters. The network switch may, in response to determining the command is not currently performable, re-determine, at a specified future time, whether the command will be performable at the specified future time based at least in part on comparing the set of state information of the network switch at the specified future time with the prioritized state of state parameters.

### BACKGROUND

A network switch may connect to client devices and may manage the flow of data between clients by receiving, processing, and forwarding data between the client devices. A network management system (NMS) may be a system that may connect to and manage network devices, such as network switches, in a network. The NMS may send commands to the network devices that it manages to control the network devices and to update their configurations.

The description provided in the background section should not be assumed to be prior art merely because it is mentioned in or associated with the background section. The background section may include information that describes one or more aspects of the subject technology.

### BRIEF DESCRIPTION OF THE DRAWINGS

The accompanying drawings, which are included to provide further understanding and are incorporated in and constitute a part of this specification, illustrate disclosed embodiments and together with the description serve to explain the principles of the disclosed embodiments. In the drawings:

FIG. 1 illustrates an example architecture for priority-based decision making by a network switch.

FIG. 2 is a block diagram illustrating the example network switch from the architecture of FIG. 1 according to certain aspects of the disclosure.

FIG. 3 illustrates an example prioritized set of state parameters of FIG. 2.

FIG. 4 illustrates an example process for priority-based decision making using the example network switch of FIGS. 1 and 2.

FIG. 5 is a block diagram illustrating an example computer system with which the example network switch of FIGS. 1 and 2 can be implemented.

In one or more implementations, not all of the depicted components in each figure may be required, and one or more implementations may include additional components not shown in a figure. Variations in the arrangement and type of the components may be made without departing from the scope of the subject disclosure. Additional components, different components, or fewer components may be utilized within the scope of the subject disclosure.

### DETAILED DESCRIPTION

The detailed description set forth below is intended as a description of various implementations and is not intended to represent the only implementations in which the subject technology may be practiced. As those skilled in the art would realize, the described implementations may be modified in various different ways, all without departing from the scope of the present disclosure. Accordingly, the drawings and description are to be regarded as illustrative in nature and not restrictive.

### General Overview

The disclosed system provides for a network switch that uses a prioritized set of state parameters to automatically govern, without the need for user intervention, whether the network switch can execute a command. The prioritized set of parameters may specify conditions of the network switch under which a command can or cannot be executed by the network switch at that time.

The network switch may receive a request from a network management system to perform a command and may determine whether it is able to perform the command by comparing the current state of the network switch with the prioritized set of state parameters. The set of state parameters are prioritized so that certain state parameters are deemed to have a higher priority than other state parameters in the set of state parameters. Thus, the current state of the network switch may be deemed to meet the conditions of the set of state parameters if it meets some of the conditions of state parameters having a higher priority, even if it does not meet the conditions of all of the state parameters in the set of state parameters.

If the network switch determines that it is able to perform the command, the network switch may perform the command. If the network switch determines that it is not able to perform the command, the network switch may send a request for the network management system to re-send the request to perform the command at a specified future time. At the specified future time, the network switch may once again receive the request to perform the command and may determine, based on comparing the state of the network switch at that time with the prioritized set of state parameters, whether it is able to perform the command.

According to certain aspects of the present disclosure, a method is provided. The method includes determining, by a network switch, a prioritized set of state parameters for the network switch. The method further includes receiving, by the network switch, an indication of a command. The method further includes in response to receiving the indication of the command to be performed by the network switch, determining, by the network switch, whether the command is currently performable based at least in part on comparing a set of current state information of the network switch with the prioritized set of state parameters. The method further includes in response to determining the command is not currently performable, re-determining, by the network switch at a specified future time, whether the command will be performable at the specified future time based at least in part on comparing the set of state information of the network switch at the specified future time with the prioritized state of state parameters.

According to certain aspects of the present disclosure, a network switch is provided. The network switch includes a memory comprising a prioritized set of state parameters for the network switch. The network switch further includes a processor configured to execute instructions which, when executed, cause the processor to: receive an indication of a command; in response to receiving the indication of the command to be performed by the network switch, determine whether the command is currently performable based at least in part on comparing a set of current state information of the network switch with the prioritized set of state parameters; and in response to determining the command is not currently performable, re-determine, at a specified future time, whether the command will be performable at the specified future time based at least in part on comparing the set of state information of the network switch at the specified future time with the prioritized state of state parameters.

According to certain aspects of the present disclosure, an apparatus is provided. The apparatus includes means for determining a prioritized set of state parameters for the network switch. The apparatus further includes means for receiving an indication of a command. The apparatus further includes in response to receiving the indication of the command to be performed by the network switch, determining whether the command is currently performable based at least in part on comparing a set of current state information of the network switch with the prioritized set of state parameters. The apparatus further includes in response to determining the command is not currently performable, re-determining, at a specified future time, whether the command will be performable at the specified future time based at least in part on comparing the set of state information of the network switch at the specified future time with the prioritized state of state parameters.

According to certain aspects of the present disclosure, a non-transitory machine-readable storage medium comprising machine-readable instructions for causing a processor at a network switch to execute a method is provided. The method includes determining a prioritized set of state parameters for the network switch. The method further includes receiving an indication of a command. The method further includes in response to receiving the indication of the command to be performed by the network switch, determining whether the command is currently performable based at least in part on comparing a set of current state information of the network switch with the prioritized set of state parameters. The method further includes in response to determining the command is not currently performable, re-determining, at a specified future time, whether the command will be performable at the specified future time based at least in part on comparing the set of state information of the network switch at the specified future time with the prioritized state of state parameters.

It is understood that other configurations of the subject technology will become readily apparent to those skilled in the art from the following detailed description, wherein various configurations of the subject technology are shown and described by way of illustration. As will be realized, the subject technology is capable of other and different configurations and its several details are capable of modification in various other respects, all without departing from the scope of the subject technology. Accordingly, the drawings and detailed description are to be regarded as illustrative in nature and not as restrictive.

The disclosed system addresses a technical problem tied to computer technology and arising in the realm of computer networks, namely the technical problem of a network switch executing certain commands it receives that may cause disruptions to the network switch as a result of executing such commands. Such disruptions as a result of executing certain commands may include disconnecting active clients connected to the network switch, interrupting applications executing at the network switch, temporarily making the network switch unavailable in a network where the switch is handling certain volume of data at the network switch, and the like.

The disclosed system solves this technical problem by determining whether the network switch is in a state where executing a command would disrupt the functioning of the network switch by comparing the state of the network switch to a prioritized set of state parameters and, if so, refrain from performing the command. Instead, the network switch may re-determine, at a later time, whether the command would disrupt the functioning of the network switch at the later time and, if not, may perform the command at the later time. The disclosed system thereby improves the reliability of the network switch by decreasing amount of downtime caused by the network switch executing commands that disrupts the functioning of the network switch.

### Example System Architecture

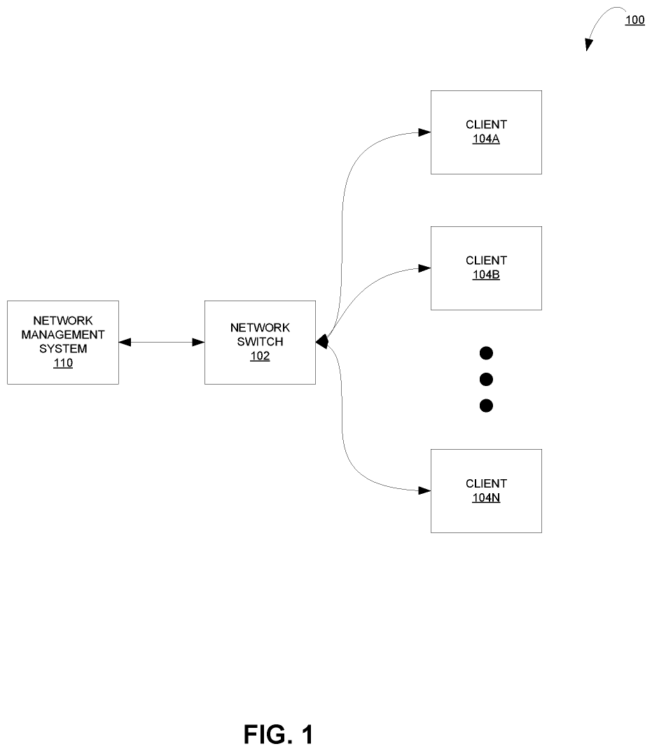

FIG. 1 illustrates an example architecture 100 for priority-based decision making by a network switch. The architecture 100 includes network switch 102 connected to clients 104A-104N (hereafter “clients 104) and network management system (NMS) 110.

Network switch 102 is configured to connect clients 104 and to manage the flow of data between clients 104 by receiving, processing, and forwarding data between clients 104. Clients 104 can be, for example, desktop computers, mobile computers, tablet computers (e.g., including e-book readers), mobile devices (e.g., a smartphone or PDA), set top boxes (e.g., for a television), video game consoles, or any other devices having appropriate processor, memory, and communications capabilities.

NMS 110 may be any suitable system comprising one or more network devices that is configured to manage network devices such as network switches (e.g., network switch 102), routers, access points, gateways, and the like. NMS 110 may connect to network devices, such as network switch 102, via a network such as a wide area network (e.g., the Internet), a local area network, and the like, via wired or wireless means, such as Ethernet or WiFi. NMS 110 may transmit commands to network devices that it manages that the network devices may receive and execute. The commands may include a reboot command, command for configuration changes, and any other suitable commands for managing and/or configuring network devices.

In accordance with aspects of the present disclosure, NMS 110 may send a command to network switch 102 that is to be performed by network switch 102, and network switch 102 may receive an indication of the command sent from NMS 110. When network switch 102 receives the indication of the command from NMS 110, network switch 102 may determine whether performing the command would disrupt operations of network switch 102. To make such a determination, network switch 102 may determine a prioritized set of state parameters for network switch 102. The prioritized set of state parameters may specify the conditions under which the performance of the command may disrupt the operations of network switch 102. Because different commands may affect and change network switch 102 in different ways, network switch 102 may select the prioritized set of state parameters associated with the command it receives out of a plurality of prioritized sets of state parameters.

Network switch 102 may, in response to receiving the indication of the command to be performed by the network switch 102, determine whether the command is currently performable based at least in part on comparing a set of current state information of the network switch 102 with the prioritized set of state parameters. Network switch 102 may determine whether its state meets the conditions specified by the prioritized set of state parameters under which the performance of the command may disrupt the operations of network switch 102 by comparing the set of current state information of network switch 102 with the prioritized set of state parameters. If network switch 102 determines that the performance of the command would not disrupt the operations of network switch 102, network switch 102 may determine that the command is currently performable and may perform the command. Conversely, if network switch 102 determines that the performance of the command would disrupt the operations of network switch 102, network switch 102 may determine that the command is not currently performable.

If network switch 102 determines that the command is not currently performable, network switch 102 may attempt to perform the command at a later time when performance of the command may not disrupt the operations of network switch 102. When network switch 102 attempts to perform the command at the later time, network switch 102 may determine, at the later time, whether performance of the command would disrupt the operations of network switch 102 by comparing the set of state information of network switch 102 at that later time with the prioritized set of state parameters.

As such, network switch 102 may, in response to determining the command is not currently performable, re-determine, at a specified future time that is a specified time period after the determining of whether the command is currently performable, whether the command will be performable at the specified future time based at least in part on comparing the set of state information of the network switch at the specified future time with the prioritized state of state parameters. If network switch 102 determines that the command is performable, network switch 102 may perform the command. If network switch 102 determines that the command is not performable, network switch 102 may continue to re-determine whether the command is performable until network switch 102 determines that the command is performable, or until the number of times network switch 102 determines whether the command is performable reaches a specified threshold, at which point network switch 102 may send an error message to NMS 110.

### Example Network Switch

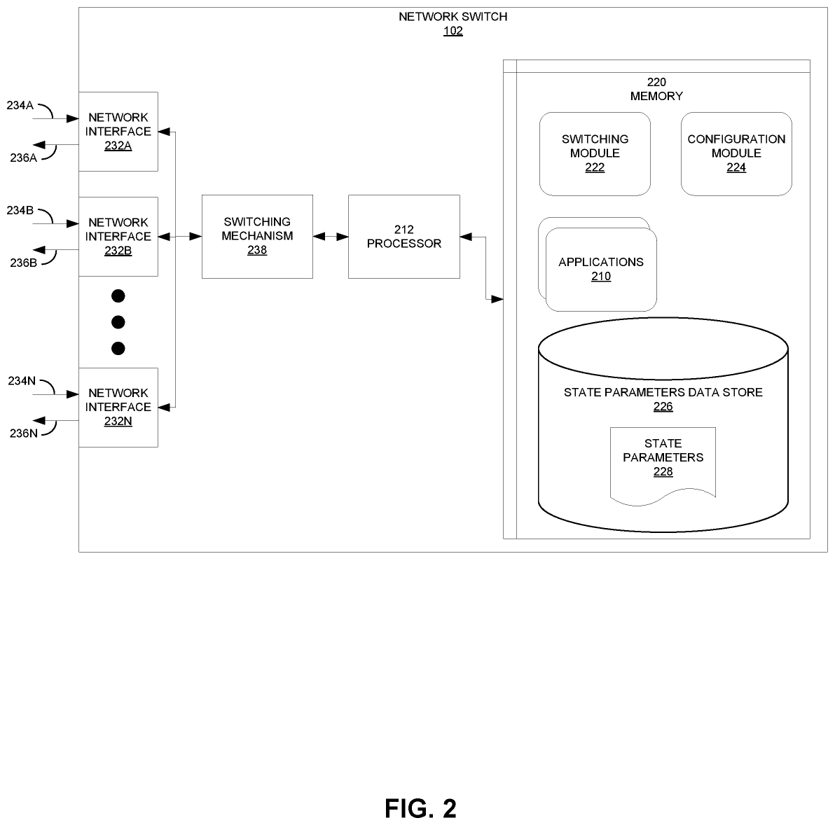

FIG. 2 is a block diagram illustrating the example network switch 102 in the architecture 100 of FIG. 1 according to certain aspects of the disclosure. As shown in FIG. 2, network switch 102 includes network interfaces 232A-232N (hereafter network interfaces 232), switching mechanism 238, processor 212, and memory 220 that includes switching module 222, configuration module 224, state parameters data store 226, and applications 210.

The processor 212 of network switch 102 is configured to execute instructions, such as instructions physically coded into the processor 212, instructions received from software in memory 220, or a combination of both. For example, processor 212 executes instructions of switching module 222, configuration module 224, and applications 210 to perform the techniques disclosed throughout this disclosure.

Switching module 222 may be software for controlling switching mechanism 238. Configuration module 224 may be software for receiving a command to be performed by network switch 102 from NMS 110, for determining whether the command is able to be performed by network switch 102, as described in further details below. Applications 210 may include any other suitable software or applications that may execute at processor 212 of network switch 102. Examples of applications 210 may include a Dynamic Host Configuration Protocol (DHCP) application or a Domain Name System (DNS) application.

Network interfaces 232 may be electrically coupled to switching mechanism 238. Switching mechanism 238 be a switch fabric, switchgear, or other high-speed switching mechanisms, via any suitable communication paths, such as busses and the like, that is configured to control the flow of data between input links 234 and output links 236 in order to route data between any of input links 234 and output links 236. Processor 212 may be configured to execute switching module 222 to control switching mechanism 228 to thereby control the routing of data between input links 234 and output links 236 of network interfaces 232.

State parameters data store 226 in memory 220 may be configured to store prioritized sets of state parameters 228 that network switch 102 may use to determine whether it can perform a command that it receives. For example, the prioritized sets of state parameters 228 may be specified by a user, such as an administrator of network switch 102 or a network administrator. Each prioritized set of state parameters may be associated with a particular command, so that configuration module 224 may execute at processor 212 to select a prioritized set of state parameters from the prioritized sets of state parameters stored in state parameters data store 226 based on the command received from NMS 110.

In accordance with aspects of the present disclosure, network switch 102 may receive an indication of a command. In the example of architecture 100, network switch 102 may receive the indication of the command from NMS 110. The command may be any suitable command that may be performed by network switch 102. In some examples, the command includes one of: a reboot command, a configuration push, a control plane policing policy change, or a device profiling command.

A reboot command may be performed by network switch 102 to reboot itself. A configuration push may specify a set of configuration updates to network switch 102, and the configuration push may be performed by network switch 102 to update its configuration according to the configuration updates specified by the configuration push. A control plane policing policy change may specify a change to a quality of service (QoS) filter of network switch 102, and network switch 102 may perform the control plane policing policy change to update the QoS filter specified by the control plane policing policy change. A device profiling command may be a command to profile switch 102, and network switch 102 may perform the profiling command to collect and send a profile of network switch 102 to NMS 110.

Processor 212 of network switch 102 may perform instructions to determine whether it can perform the command based on its current state. Processor 212 of network switch 102 may perform instructions to determine, based on its current state, the amount of disruption to the functioning of network switch 102 that would be caused by performing the command. For example, if one or more active clients are connected to network switch 102, performing a reboot command may cause disruption to the functioning of network switch 102 by disconnecting such active clients from network switch 102.

Processor 212 of network switch 102 may perform instructions to specify the conditions of its state under which it may or may not perform a command by determining a prioritized set of state parameters that may specify conditions under which performing the command may disrupt operations of network switch 102. In particular, processor 212 of network switch 102 may perform instructions to determine a prioritized set of state parameters and may, in response to receiving the indication of the command to be performed by network switch 102, determine whether the command is currently performable based at least in part on comparing a set of current state information of network switch 102 with the prioritized set of state parameters to determine whether the set of current state information of network switch 102 meets the conditions specified by the prioritized set of state parameters.

The prioritized set of state parameters 228 may include state parameters, which specifies conditions under which network switch 102 may or may not be able to perform a command. Examples of state parameters may include the number of active clients connected to network switch 102, the amount of traffic at network interfaces 232, the applications 228 executing at network switch 102, active communications sessions (e.g., Secure Shell sessions) at network switch 102, network activity at network switch 102, and the like. Thus, for example, a state parameter may specify of the number of active clients at network switch 102 being more than zero as a condition in which network switch 102 is not able to perform the command.

Different commands, when performed by network switch 102 may affect the functioning of network switch 102 in different ways. Thus, different state parameters may govern whether network switch 102 is able to perform different commands. As such, processor 212 of network switch 102 may perform instructions to select, based at least in part on the command received by network switch 102, the prioritized set of state parameters that is used to determine whether the command is currently performable out of a plurality of prioritized sets of state parameters stored in state parameters data store 226.

The state parameters in a prioritized set of state parameters 228 may be associated with priority values, such that each state parameter in a prioritized set of state parameters is associated with a priority value. A prioritized set of state parameters 228 that includes state parameters associated with priority values may enable network switch 102 to prioritize the conditions under which network switch 102 may or may not perform commands.

The priority value associated with a state parameter may indicate the priority level of the state parameter. The priority level of the state parameter may indicate the relative importance of whether the state of network switch 102 meets the state parameter in determining whether network switch 102 is able to execute a command.

The priority level may be relative to the other state parameters in the prioritized set of state parameters, or may be absolute. In one example, the priority levels associated with state parameters may be high priority, medium priority, and/or low priority, which may be absolute or relative to other state parameters in a prioritized set of state parameters. In another example, the state parameters within a prioritized set of state parameters may be ordered, such that a first state parameter may be associated with a highest priority in the prioritized set of state parameters, a second state parameter may be associated with a second highest priority in the prioritized set of state parameters, a third state parameter may be associated with a third highest priority in the prioritized set of state parameters, and the like.

An example prioritized set of state parameters 228 may include the following state parameters:

1. Active clients>0;
2. Traffic>20% on any network interface of the network switch;
3. One or more of Dynamic Host Configuration Protocol (DHCP) or Domain Name System (DNS) application currently running on the network switch;
4. Open Secure Shell (SSH) sessions at the network switch.

In this example, the prioritized set of state parameters may include a first state parameter that one or more active clients are connected to network switch 102, a second state parameter that the traffic be higher than 20% at any one of network interfaces 232 of network switch 102, a third state parameter that a DHCP application or a DNS application be running at network switch 102, and a fourth parameter that one or more SSH sessions are open at network switch 102.

Each of the state parameters may evaluate to true if the current state of network switch 102 meets the conditions of the respective state parameter, and may evaluate to false if the current state of network switch 102 does not meet the conditions of the respective state parameter. For example, the first state parameter evaluates to true if one or more active clients are connected to network switch 102, the second state parameter evaluates to true if the traffic is higher than 20% at any one of network interfaces 232 of network switch 102, the third state parameter evaluates to true if a DHCP application or a DNS application is running at network switch 102, and the fourth parameter evaluates to true if one or more SSH sessions are open at network switch 102

Each of the state parameters from prioritized set of state parameters is associated with a priority value which may be used to determine whether network switch 102 is able to perform a command. In one example, a prioritized set of state parameters may include a plurality of state parameters associated with a high priority and one or more state parameters associated with a low priority. In this example, processor 212 of network switch 102 may perform instructions to determine that the command is currently performable if the set of current state information does not meet the conditions of each of the plurality of state parameters associated with a high priority regardless of whether the set of current state information meets the conditions of the one or more state parameters associated with a low priority.

In the example of the prioritized set of state parameters 228, the first, second and third state parameters may each be associated with a high priority, and the fourth state parameter may be associated with a low priority. Thus, processor 212 of network switch 102 may perform instructions to determine that the command is currently performable as long as it does not meet the conditions of any of the first, second, and third state parameters regardless of whether it meets the conditions of the fourth state parameter.

In another example, a prioritized set of state parameters 228 may include one or more state parameters associated with a high priority and a plurality of state parameters associated with a low priority. In this example, processor 212 of network switch 102 may perform instructions to determine that the command is currently performable if the set of current state information meets the conditions of one of the plurality of state parameters associated with the low priority evaluates and if the set of current state information does not meet the conditions of any of remaining state parameters from the prioritized set of state parameters.

In the example of the prioritized set of state parameters 228, the first, second and third state parameters may each be associated with a high priority, and the fourth state parameter may be associated with a low priority. Thus, processor 212 of network switch 102 may perform instructions to determine that the command is currently performable if it meets the fourth state parameter as long as it does not meet the conditions of any of the first, second, and third state parameters.

In some examples, the prioritized set of state parameters 228 may include one or more state parameters associated with a high priority, and a plurality of state parameters associated with a low priority. In this example, processor 212 of network switch 102 may perform instructions to may determine that the command is currently performable if the set of current state information meets the conditions of one of the plurality of state parameters associated with the low priority evaluates and if the set of current state information does not meet the conditions of any of remaining state parameters from the prioritized set of state parameters.

In the example of the prioritized set of state parameters 228, the first and second state parameters may each be associated with a high priority, and the third and fourth state parameter may each be associated with a low priority. Thus, processor 212 of network switch 102 may perform instructions to determine that the command is currently performable if it meets only one of the third or fourth state parameter as long as it does not meet the conditions of the remaining state parameters.

As can be seen by the above examples, by prioritizing the set of state parameters 228, the disclosed system provides a great level of control in determining the states in which network switch 102 is able to perform a command, and the states in which network switch 102 is not able to perform a command based on the current state of network switch 102. In this way, the disclosed system provides a technical advantage over systems that do not utilize such prioritized sets of state parameters by enabling greater, finer-grained control over the conditions under which network switch 102 is able or is not able to perform a command that it receives from NMS 110 or another external system.

Network switch 102 may, in response to determining that the command is currently performable, perform the command. Conversely, if network switch 102 determines that the command is not currently performable, network switch 102 may refrain from performing the command. Instead, in response to determining that the command is not currently performable, network switch 102 may re-determine, at a specified future time that is a time period after the determining of whether the command is currently performable, whether the command will be performable at the specified future time based at least in part on comparing the set of state information of network switch 102 at the specified future time with the prioritized state of state parameters.

Thus, if network switch 102 determines that the command is not currently performable, network switch 102 may refrain from performing the command, and may instead determine, at a later time that is a time period after the determining of whether the command is currently performable, whether it is able to perform the command at a later time. The time period after the determining of whether the command is currently performable may be any suitable time period such as 3 seconds, 5 seconds, and the like. In some examples, network switch 102 may store the command in memory 220 and may schedule a job (e.g., a cron job) to perform the command at the later time if network switch 102 determines that it is able to perform the command at that time.

In another example, network switch 102 may send a request to NMS 110 that originally sent the command to re-send the command at the later time that is a time period after the determining of whether the command is currently performable. Such a request may be a Representational State Transfer (REST) request for NMS 110 to schedule a job to send the command at a specified later time. As a result, at the later specified time, NMS 110 may re-send, and network switch 102 may once again receive, an indication of the command to be performed.

When the specified future time that a time that is a time period after the determining of whether the command is currently performable is reached, network switch 102 may re-determine whether it is able to perform the command at the specified future time based at least in part on comparing the set of state information of network switch 102 at the specified future time with the prioritized state of state parameters. Because the state of network switch 102 may have changed during the time period after it first determined that the command was not performable, the result of whether the command is performable may differ from network switch 102's first determination that the command was not performable.

In the example where network switch 102 sends a request to NMS 110 to re-send the command, NMS 110 may resent the indication of the command at the specified future time that is a time period after the determining of whether the command is currently performable. In response to receiving an indication of the command that is re-sent by NMS 110 at the specified future time, network switch 102 may determine whether the command is performable at the specified future time based at least in part on comparing the set of state information of network switch 102 at the specified future time with the prioritized state of state parameters.

If network switch 102 determines that the command is performable, the network switch 102 may perform the command. If network switch 102 determines that the command is not performable, network switch 102 may once again wait a second time period after re-determining whether the command is performable to once again re-determine whether the command is performable after the specified time period, where the time period after the determining of whether the command is currently performable is a first time period.

Network switch 102 may double the time period it waits each time it re-determines whether the command is performable. Thus, if network switch 102 originally determines that the command is not performable and waits until a first time at a first time period after the determination to re-determine whether the command is performable, and if network switch 102 determines that the command is not performable at the first time, network switch 102 may wait until a second time at a second time period after the re-determination to again re-determine whether the command is performable, and the second time period may be at least double the first time period. If network switch 102 determines that once again the command is not performable at the second time, network switch 102 may wait until a third time at a third time period after the second time to again re-determine whether the command is performable, and the third time period may be at least double the second time period, and so on.

In some examples, network switch 102 may perform commands sent or inputted by certain users, such as administrators of network switch 102, without determining whether the command is performable based on comparing the state of network switch 102 with a prioritized set of state parameters. This may be useful to override any faulty scenarios that may arise. Thus, network switch may receive an indication of a command and, in response to determining that the switch is received from an administrator of network switch 102, perform the received command.

The techniques described herein may be implemented as method(s) that are performed by physical computing device(s); as one or more non-transitory computer-readable storage media storing instructions which, when executed by computing device(s), cause performance of the method(s); or, as physical computing device(s) that are specially configured with a combination of hardware and software that causes performance of the method(s).

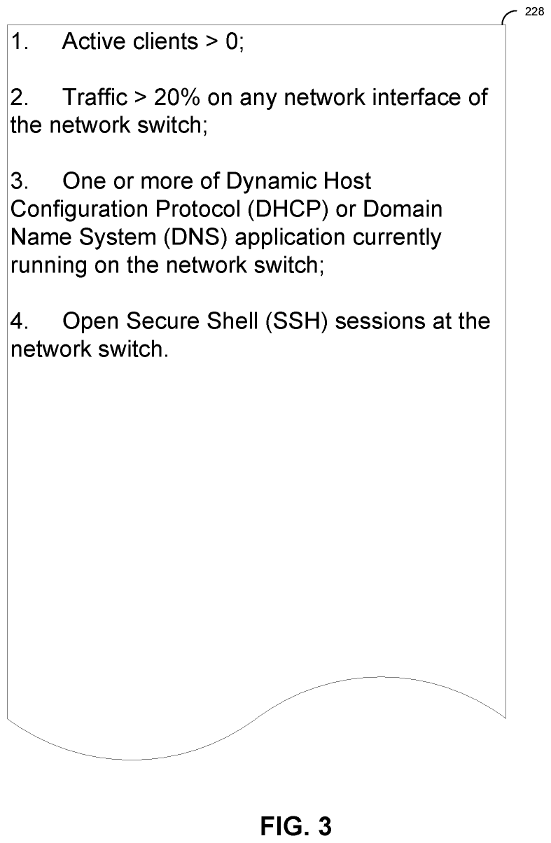

FIG. 3 illustrates an example prioritized set of state parameters 228 of FIG. 2. As shown in FIG. 3, the example prioritized set of state parameters 228 includes the following state parameters:

1. Active clients>0;
2. Traffic>20% on any network interface of the network switch;
3. One or more of Dynamic Host Configuration Protocol (DHCP) or Domain Name System (DNS) application currently running on the network switch;
4. Open Secure Shell (SSH) sessions at the network switch.

In this example, the prioritized set of state parameters may include a first state parameter that one or more active clients are connected to network switch 102, a second state parameter that the traffic be higher than 20% at any one of network interfaces 232 of network switch 102, a third state parameter that a DHCP application or a DNS application be running at network switch 102, and a fourth parameter that one or more SSH sessions are open at network switch 102.

Each of the state parameters may evaluate to true if the current state of network switch 102 meets the conditions of the respective state parameter, and may evaluate to false if the current state of network switch 102 does not meet the conditions of the respective state parameter. For example, the first state parameter evaluates to true if one or more active clients are connected to network switch 102, the second state parameter evaluates to true if the traffic is higher than 20% at any one of network interfaces 232 of network switch 102, the third state parameter evaluates to true if a DHCP application or a DNS application is running at network switch 102, and the fourth parameter evaluates to true if one or more SSH sessions are open at network switch 102

Each of the state parameters from prioritized set of state parameters is associated with a priority value which may be used to determine whether network switch 102 is able to perform a command. In one example, a prioritized set of state parameters may include a plurality of state parameters associated with a high priority and one or more state parameters associated with a low priority. In this example, processor 212 of network switch 102 may perform instructions to determine that the command is currently performable if the set of current state information does not meet the conditions of each of the plurality of state parameters associated with a high priority regardless of whether the set of current state information meets the conditions of the one or more state parameters associated with a low priority.

In the example of the prioritized set of state parameters 228, the first, second and third state parameters may each be associated with a high priority, and the fourth state parameter may be associated with a low priority. Thus, processor 212 of network switch 102 may perform instructions to determine that the command is currently performable as long as it does not meet the conditions of any of the first, second, and third state parameters regardless of whether it meets the conditions of the fourth state parameter.

In another example, a prioritized set of state parameters 228 may include one or more state parameters associated with a high priority and a plurality of state parameters associated with a low priority. In this example, processor 212 of network switch 102 may perform instructions to determine that the command is currently performable if the set of current state information meets the conditions of one of the plurality of state parameters associated with the low priority evaluates and if the set of current state information does not meet the conditions of any of remaining state parameters from the prioritized set of state parameters.

In the example of the prioritized set of state parameters 228, the first, second and third state parameters may each be associated with a high priority, and the fourth state parameter may be associated with a low priority. Thus, processor 212 of network switch 102 may perform instructions to determine that the command is currently performable if it meets the fourth state parameter as long as it does not meet the conditions of any of the first, second, and third state parameters.

In some examples, the prioritized set of state parameters 228 may include one or more state parameters associated with a high priority, and a plurality of state parameters associated with a low priority. In this example, processor 212 of network switch 102 may perform instructions to may determine that the command is currently performable if the set of current state information meets the conditions of one of the plurality of state parameters associated with the low priority evaluates and if the set of current state information does not meet the conditions of any of remaining state parameters from the prioritized set of state parameters.

In the example of the prioritized set of state parameters 228, the first and second state parameters may each be associated with a high priority, and the third and fourth state parameter may each be associated with a low priority. Thus, processor 212 of network switch 102 may perform instructions to determine that the command is currently performable if it meets only one of the third or fourth state parameter as long as it does not meet the conditions of the remaining state parameters.

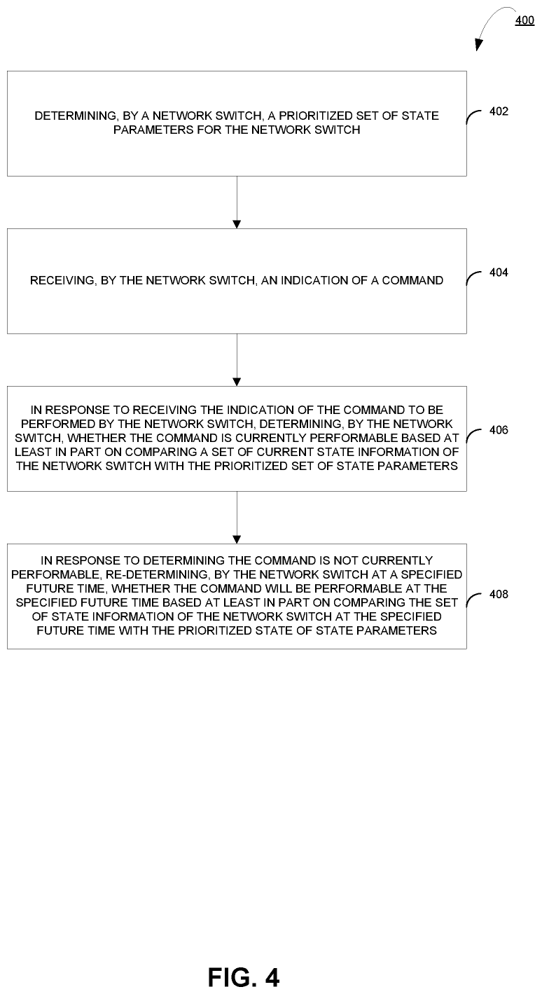

FIG. 4 illustrates an example process 400 for or priority-based decision making by a network switch using the example network switch 102 of FIGS. 1 and 2. While FIG. 4 is described with reference to FIGS. 1 and 2, it should be noted that the process steps of FIG. 4 may be performed by other systems.

The process 400 begins by proceeding to step 402 where network switch 102 determines a prioritized set of state parameters 228 for the network switch 102. In some examples, network switch 102 may select, based at least in part on the command, the prioritized set of state parameters that is used to determine whether the command is currently performable out of a plurality of prioritized sets of state parameters. In some examples, the prioritized set of state parameters includes one or more of: a first state parameter associated with a number of active clients at the network switch, a second state parameter associated with an amount of traffic at any one of network interfaces of the network switch, a third state parameter associated with one or more applications executing at the network switch, or a fourth state parameter associated with an open Secure Shell (SSH) sessions at the network switch.

The process 400 proceeds to step 404 where network switch 102 receives an indication of a command to be performed by the network switch 102. In some examples, the command may include one of: a reboot command, a configuration push, a control plane policing policy change, or a device profiling command.

The process 400 proceeds to step 406 where network switch 102, in response to receiving the indication of the command to be performed by the network switch 102, determines whether the command is currently performable based at least in part on comparing a set of current state information of the network switch 102 with the prioritized set of state parameters 228.

In some examples, the prioritized set of state parameters 228 include a plurality of state parameters associated with a high priority, and one or more state parameters associated with a low priority, and network switch 102 determining whether the command is currently performable based at least in part on comparing the set of current state information of the network switch with the prioritized set of state parameters 228 further includes network switch 102 determining the command is currently performable if the set of current state information does not meet each of the plurality of state parameters associated with the high priority.

In some examples, the prioritized set of state parameters 228 include a plurality of state parameters associated with a high priority, and one or more state parameters associated with a low priority, and network switch 102 determining whether the command is currently performable based at least in part on comparing the set of current state information of the network switch with the prioritized set of state parameters 228 further includes network switch 102 determining the command is not currently performable if the set of current state information meets one or more of the plurality of state parameters associated with the high priority.

In some examples, the prioritized set of state parameters 228 include one or more state parameters associated with a high priority, and a plurality of state parameters associated with a low priority, and network switch 102 determining whether the command is currently performable based at least in part on comparing the set of current state information of the network switch with the prioritized set of state parameters 228 further includes network switch 102 determining the command is currently performable if the set of current state information meets one of the plurality of state parameters associated with the low priority evaluates and if the set of current state information does not meet any of remaining state parameters from the prioritized set of state parameters 228.

The process 400 proceeds to step 408 where network switch 102, in response to determining the command is not currently performable, re-determines, at a specified future time, whether the command will be performable at the specified future time based at least in part on comparing the set of state information of the network switch 102 at the specified future time with the prioritized state of state parameters 228.

In some examples, network switch 102, in response to determining the command is not currently performable, re-determines, at a specified future time, whether the command will be performable at the time based at least in part on comparing the set of state information of the network switch 102 at the specified future time with the prioritized state of state parameters 228 further includes in response to determining the command is not currently performable, the network switch 102 sending to a network management system 110, a request to re-send the command at the specified future time and, in response to receiving an indication of the command that is re-sent by the network management system 110 at the specified future time, the network switch 102 determining whether the command is performable at the specified future time based at least in part on comparing the set of state information of the network switch 102 at the specified future time with the prioritized state of state parameters 228.

In some examples, the specified future time is a first specified future time that is a first specified time period after the determining of whether the command is currently performable, and the process 300 may further include the network switch 102 determining that the command is not performable at the first specified future time and, in response to determining that the command is not performable at the first specified future time, the network switch 102 re-determining at a second specified future time that is a second specified time period after the first specified future time, whether the command is performable at the second specified future time based at least in part on comparing the set of state information of the network switch 102 at the second specified future time with the prioritized state of state parameters 228, wherein the second specified time period is at least double the first specified time period.

In some examples, the command is a first command, and the process 400 may further include network switch 102 receiving, an indication of a second command and, in response to determining that the second command is received from an administrator of the network switch 102, network switch 102 may perform the second command.

### Hardware Overview

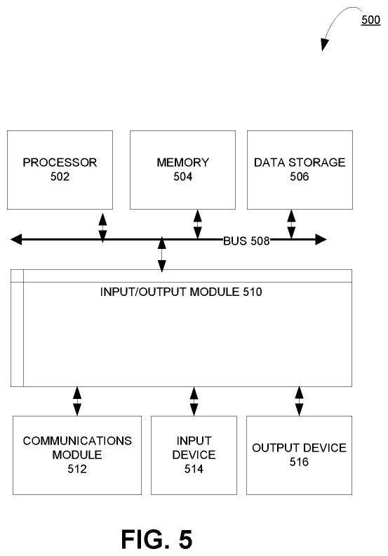

FIG. 5 is a block diagram illustrating an example computer system 500 with which network switch 102 of FIGS. 1 and 2 can be implemented. In certain aspects, the computer system 500 may be implemented using hardware or a combination of software and hardware, either in a dedicated server, or integrated into another entity, or distributed across multiple entities.

Computer system 500 (e.g., switch 102) includes a bus 508 or other communication mechanism for communicating information, and a processor 502 (e.g., processor 212) coupled with bus 508 for processing information. According to one aspect, the computer system 500 can be a cloud computing server of an IaaS that is able to support PaaS and SaaS services. According to one aspect, the computer system 600 is implemented as one or more special-purpose computing devices. The special-purpose computing device may be hard-wired to perform the disclosed techniques, or may include digital electronic devices such as one or more application-specific integrated circuits (ASICs) or field programmable gate arrays (FPGAs) that are persistently programmed to perform the techniques, or may include one or more general purpose hardware processors programmed to perform the techniques pursuant to program instructions in firmware, memory, other storage, or a combination. Such special-purpose computing devices may also combine custom hard-wired logic, ASICs, or FPGAs with custom programming to accomplish the techniques. The special-purpose computing devices may be desktop computer systems, portable computer systems, handheld devices, networking devices or any other device that incorporates hard-wired and/or program logic to implement the techniques. By way of example, the computer system 500 may be implemented with one or more processors 502. Processor 502 may be a general-purpose microprocessor, a microcontroller, a Digital Signal Processor (DSP), an ASIC, a FPGA, a Programmable Logic Device (PLD), a controller, a state machine, gated logic, discrete hardware components, or any other suitable entity that can perform calculations or other manipulations of information.

Computer system 500 can include, in addition to hardware, code that creates an execution environment for the computer program in question, e.g., code that constitutes processor firmware, a protocol stack, a database management system, an operating system, or a combination of one or more of them stored in an included memory 504 (e.g., memory 220), such as a Random Access Memory (RAM), a flash memory, a Read Only Memory (ROM), a Programmable Read-Only Memory (PROM), an Erasable PROM (EPROM), registers, a hard disk, a removable disk, a CD-ROM, a DVD, or any other suitable storage device, coupled to bus 508 for storing information and instructions to be executed by processor 502. The processor 502 and the memory 504 can be supplemented by, or incorporated in, special purpose logic circuitry. Expansion memory may also be provided and connected to computer system 500 through input/output module 510, which may include, for example, a SIMM (Single In Line Memory Module) card interface. Such expansion memory may provide extra storage space for computer system 500, or may also store applications or other information for computer system 500. Specifically, expansion memory may include instructions to carry out or supplement the processes described above, and may include secure information also. Thus, for example, expansion memory may be provided as a security module for computer system 500, and may be programmed with instructions that permit secure use of computer system 500. In addition, secure applications may be provided via the SIMM cards, along with additional information, such as placing identifying information on the SIMM card in a non-hackable manner.

The instructions may be stored in the memory 504 and implemented in one or more computer program products, e.g., one or more modules of computer program instructions encoded on a computer readable medium for execution by, or to control the operation of, the computer system 500, and according to any method well known to those of skill in the art, including, but not limited to, computer languages such as data-oriented languages (e.g., SQL, dBase), system languages (e.g., C, Objective-C, C++, Assembly), architectural languages (e.g., Java, .NET), and application languages (e.g., PHP, Ruby, Perl, Python). Instructions may also be implemented in computer languages such as array languages, aspect-oriented languages, assembly languages, authoring languages, command line interface languages, compiled languages, concurrent languages, curly-bracket languages, dataflow languages, data-structured languages, declarative languages, esoteric languages, extension languages, fourth-generation languages, functional languages, interactive mode languages, interpreted languages, iterative languages, list-based languages, little languages, logic-based languages, machine languages, macro languages, metaprogramming languages, multiparadigm languages, numerical analysis, non-English-based languages, object-oriented class-based languages, object-oriented prototype-based languages, off-side rule languages, procedural languages, reflective languages, rule-based languages, scripting languages, stack-based languages, synchronous languages, syntax handling languages, visual languages, wirth languages, embeddable languages, and xml-based languages. Memory 504 may also be used for storing temporary variable or other intermediate information during execution of instructions to be executed by processor 502.

A computer program as discussed herein does not necessarily correspond to a file in a file system. A program can be stored in a portion of a file that holds other programs or data (e.g., one or more scripts stored in a markup language document), in a single file dedicated to the program in question, or in multiple coordinated files (e.g., files that store one or more modules, subprograms, or portions of code). A computer program can be deployed to be executed on one computer or on multiple computers that are located at one site or distributed across multiple sites and interconnected by a communication network, such as in a cloud-computing environment. The processes and logic flows described in this specification can be performed by one or more programmable processors executing one or more computer programs to perform functions by operating on input data and generating output.

Computer system 500 further includes a data storage device 506 such as a magnetic disk or optical disk, coupled to bus 508 for storing information and instructions. Computer system 500 may be coupled via input/output module 510 to various devices. The input/output module 510 can be any input/output module. Example input/output modules 510 include data ports such as USB ports. In addition, input/output module 510 may be provided in communication with processor 502, so as to enable near area communication of computer system 500 with other devices. The input/output module 510 may provide, for example, for wired communication in some implementations, or for wireless communication in other implementations, and multiple interfaces may also be used. The input/output module 510 is configured to connect to a communications module 512. Example communications modules 512 (e.g., network interfaces 232) include networking interface cards, such as Ethernet cards and modems.

The components of the system can be interconnected by any form or medium of digital data communication, e.g., a communication network. The communication network can include, for example, any one or more of a personal area network (PAN), a local area network (LAN), a campus area network (CAN), a metropolitan area network (MAN), a wide area network (WAN), a broadband network (BBN), the Internet, and the like. Further, the communication network can include, but is not limited to, for example, any one or more of the following network topologies, including a bus network, a star network, a ring network, a mesh network, a star-bus network, tree or hierarchical network, or the like. The communications modules can be, for example, modems or Ethernet cards.

For example, in certain aspects, communications module 512 can provide a two-way data communication coupling to a network link that is connected to a local network. Wireless links and wireless communication may also be implemented. Wireless communication may be provided under various modes or protocols, such as GSM (Global System for Mobile Communications), Short Message Service (SMS), Enhanced Messaging Service (EMS), or Multimedia Messaging Service (MMS) messaging, CDMA (Code Division Multiple Access), Time division multiple access (TDMA), Personal Digital Cellular (PDC), Wideband CDMA, General Packet Radio Service (GPRS), or LTE (Long-Term Evolution), among others. Such communication may occur, for example, through a radio-frequency transceiver. In addition, short-range communication may occur, such as using a BLUETOOTH, WI-FI, or other such transceiver.

In any such implementation, communications module 512 sends and receives electrical, electromagnetic or optical signals that carry digital data streams representing various types of information. The network link typically provides data communication through one or more networks to other data devices. For example, the network link of the communications module 512 may provide a connection through local network to a host computer or to data equipment operated by an Internet Service Provider (ISP). The ISP in turn provides data communication services through the world wide packet data communication network now commonly referred to as the “Internet”. The local network and Internet both use electrical, electromagnetic or optical signals that carry digital data streams. The signals through the various networks and the signals on the network link and through communications module 512, which carry the digital data to and from computer system 500, are example forms of transmission media.

Computer system 500 can send messages and receive data, including program code, through the network(s), the network link and communications module 512. In the Internet example, a server might transmit a requested code for an application program through Internet, the ISP, the local network and communications module 512. The received code may be executed by processor 502 as it is received, and/or stored in data storage 506 for later execution.

In certain aspects, the input/output module 510 is configured to connect to a plurality of devices, such as an input device 514 and/or an output device 516. Example input devices 514 include a keyboard and a pointing device, e.g., a mouse or a trackball, by which a user can provide input to the computer system 500. Other kinds of input devices 514 can be used to provide for interaction with a user as well, such as a tactile input device, visual input device, audio input device, or brain-computer interface device. For example, feedback provided to the user can be any form of sensory feedback, e.g., visual feedback, auditory feedback, or tactile feedback; and input from the user can be received in any form, including acoustic, speech, tactile, or brain wave input. Example output devices 516 include display devices, such as a LED (light emitting diode), CRT (cathode ray tube), LCD (liquid crystal display) screen, a TFT LCD (Thin-Film-Transistor Liquid Crystal Display) or an OLED (Organic Light Emitting Diode) display, for displaying information to the user. The output device 516 may comprise appropriate circuitry for driving the output device 516 to present graphical and other information to a user.

According to one aspect of the present disclosure, network switch 102 can be implemented using a computer system 500 in response to processor 502 executing one or more sequences of one or more instructions contained in memory 504. Such instructions may be read into memory 504 from another machine-readable medium, such as data storage device 506. Execution of the sequences of instructions contained in main memory 504 causes processor 502 to perform the process steps described herein. One or more processors in a multi-processing arrangement may also be employed to execute the sequences of instructions contained in memory 504. Processor 502 may process the executable instructions and/or data structures by remotely accessing the computer program product, for example by downloading the executable instructions and/or data structures from a remote server through communications module 512 (e.g., as in a cloud-computing environment). In alternative aspects, hard-wired circuitry may be used in place of or in combination with software instructions to implement various aspects of the present disclosure. Thus, aspects of the present disclosure are not limited to any specific combination of hardware circuitry and software.

Various aspects of the subject matter described in this specification can be implemented in a computing system that includes a back end component, e.g., as a data server, or that includes a middleware component, e.g., an application server, or that includes a front end component, e.g., a client computer having a graphical user interface or a Web browser through which a user can interact with an implementation of the subject matter described in this specification, or any combination of one or more such back end, middleware, or front end components. For example, some aspects of the subject matter described in this specification may be performed on a cloud-computing environment. Accordingly, in certain aspects a user of systems and methods as disclosed herein may perform at least some of the steps by accessing a cloud server through a network connection. Further, data files, circuit diagrams, performance specifications and the like resulting from the disclosure may be stored in a database server in the cloud-computing environment, or may be downloaded to a private storage device from the cloud-computing environment.

Computing system 500 can include clients and servers. A client and server are generally remote from each other and typically interact through a communication network. The relationship of client and server arises by virtue of computer programs running on the respective computers and having a client-server relationship to each other. Computer system 500 can be, for example, and without limitation, a desktop computer, laptop computer, or tablet computer. Computer system 500 can also be embedded in another device, for example, and without limitation, a mobile telephone, a personal digital assistant (PDA), a mobile audio player, a Global Positioning System (GPS) receiver, a video game console, and/or a television set top box.

The term “machine-readable storage medium” or “computer-readable medium” as used herein refers to any medium or media that participates in providing instructions or data to processor 502 for execution. The term “storage medium” as used herein refers to any non-transitory media that store data and/or instructions that cause a machine to operate in a specific fashion. Such a medium may take many forms, including, but not limited to, non-volatile media, volatile media, and transmission media. Non-volatile media include, for example, optical disks, magnetic disks, or flash memory, such as data storage device 506. Volatile media include dynamic memory, such as memory 504. Transmission media include coaxial cables, copper wire, and fiber optics, including the wires that comprise bus 508. Common forms of machine-readable media include, for example, floppy disk, a flexible disk, hard disk, magnetic tape, any other magnetic medium, a CD-ROM, DVD, any other optical medium, punch cards, paper tape, any other physical medium with patterns of holes, a RAM, a PROM, an EPROM, a FLASH EPROM, any other memory chip or cartridge, or any other medium from which a computer can read. The machine-readable storage medium can be a machine-readable storage device, a machine-readable storage substrate, a memory device, a composition of matter effecting a machine-readable propagated signal, or a combination of one or more of them.

As used in this specification of this application, the terms “computer-readable storage medium” and “computer-readable media” are entirely restricted to tangible, physical objects that store information in a form that is readable by a computer. These terms exclude any wireless signals, wired download signals, and any other ephemeral signals. Storage media is distinct from but may be used in conjunction with transmission media. Transmission media participates in transferring information between storage media. For example, transmission media includes coaxial cables, copper wire and fiber optics, including the wires that comprise bus 508. Transmission media can also take the form of acoustic or light waves, such as those generated during radio-wave and infra-red data communications. Furthermore, as used in this specification of this application, the terms “computer”, “server”, “processor”, and “memory” all refer to electronic or other technological devices. These terms exclude people or groups of people. For the purposes of the specification, the terms display or displaying means displaying on an electronic device.

In one aspect, a method may be an operation, an instruction, or a function and vice versa. In one aspect, a clause or a claim may be amended to include some or all of the words (e.g., instructions, operations, functions, or components) recited in other one or more clauses, one or more words, one or more sentences, one or more phrases, one or more paragraphs, and/or one or more claims.

To illustrate the interchangeability of hardware and software, items such as the various illustrative blocks, modules, components, methods, operations, instructions, and algorithms have been described generally in terms of their functionality. Whether such functionality is implemented as hardware, software or a combination of hardware and software depends upon the particular application and design constraints imposed on the overall system. Skilled artisans may implement the described functionality in varying ways for each particular application.

As used herein, the phrase “at least one of” preceding a series of items, with the terms “and” or “or” to separate any of the items, modifies the list as a whole, rather than each member of the list (e.g., each item). The phrase “at least one of” does not require selection of at least one item; rather, the phrase allows a meaning that includes at least one of any one of the items, and/or at least one of any combination of the items, and/or at least one of each of the items. By way of example, the phrases “at least one of A, B, and C” or “at least one of A, B, or C” each refer to only A, only B, or only C; any combination of A, B, and C; and/or at least one of each of A, B, and C.

The word “exemplary” is used herein to mean “serving as an example, instance, or illustration.” Any embodiment described herein as “exemplary” is not necessarily to be construed as preferred or advantageous over other embodiments. Phrases such as an aspect, the aspect, another aspect, some aspects, one or more aspects, an implementation, the implementation, another implementation, some implementations, one or more implementations, an embodiment, the embodiment, another embodiment, some embodiments, one or more embodiments, a configuration, the configuration, another configuration, some configurations, one or more configurations, the subject technology, the disclosure, the present disclosure, other variations thereof and alike are for convenience and do not imply that a disclosure relating to such phrase(s) is essential to the subject technology or that such disclosure applies to all configurations of the subject technology. A disclosure relating to such phrase(s) may apply to all configurations, or one or more configurations. A disclosure relating to such phrase(s) may provide one or more examples. A phrase such as an aspect or some aspects may refer to one or more aspects and vice versa, and this applies similarly to other foregoing phrases.

A reference to an element in the singular is not intended to mean “one and only one” unless specifically stated, but rather “one or more.” Pronouns in the masculine (e.g., his) include the feminine and neuter gender (e.g., her and its) and vice versa. The term “some” refers to one or more. Underlined and/or italicized headings and subheadings are used for convenience only, do not limit the subject technology, and are not referred to in connection with the interpretation of the description of the subject technology. Relational terms such as first and second and the like may be used to distinguish one entity or action from another without necessarily requiring or implying any actual such relationship or order between such entities or actions. All structural and functional equivalents to the elements of the various configurations described throughout this disclosure that are known or later come to be known to those of ordinary skill in the art are expressly incorporated herein by reference and intended to be encompassed by the subject technology. Moreover, nothing disclosed herein is intended to be dedicated to the public regardless of whether such disclosure is explicitly recited in the above description. No claim element is to be construed under the provisions of 35 U.S.C. § 112, sixth paragraph, unless the element is expressly recited using the phrase “means for” or, in the case of a method claim, the element is recited using the phrase “step for”.

While this specification contains many specifics, these should not be construed as limitations on the scope of what may be claimed, but rather as descriptions of particular implementations of the subject matter. Certain features that are described in this specification in the context of separate embodiments can also be implemented in combination in a single embodiment. Conversely, various features that are described in the context of a single embodiment can also be implemented in multiple embodiments separately or in any suitable subcombination. Moreover, although features may be described above as acting in certain combinations and even initially claimed as such, one or more features from a claimed combination can in some cases be excised from the combination, and the claimed combination may be directed to a subcombination or variation of a subcombination.

The subject matter of this specification has been described in terms of particular aspects, but other aspects can be implemented and are within the scope of the following claims. For example, while operations are depicted in the drawings in a particular order, this should not be understood as requiring that such operations be performed in the particular order shown or in sequential order, or that all illustrated operations be performed, to achieve desirable results. The actions recited in the claims can be performed in a different order and still achieve desirable results. As one example, the processes depicted in the accompanying figures do not necessarily require the particular order shown, or sequential order, to achieve desirable results. In certain circumstances, multitasking and parallel processing may be advantageous. Moreover, the separation of various system components in the aspects described above should not be understood as requiring such separation in all aspects, and it should be understood that the described program components and systems can generally be integrated together in a single software product or packaged into multiple software products.

The title, background, brief description of the drawings, abstract, and drawings are hereby incorporated into the disclosure and are provided as illustrative examples of the disclosure, not as restrictive descriptions. It is submitted with the understanding that they will not be used to limit the scope or meaning of the claims. In addition, in the detailed description, it can be seen that the description provides illustrative examples and the various features are grouped together in various implementations for the purpose of streamlining the disclosure. The method of disclosure is not to be interpreted as reflecting an intention that the claimed subject matter requires more features than are expressly recited in each claim. Rather, as the claims reflect, inventive subject matter lies in less than all features of a single disclosed configuration or operation. The claims are hereby incorporated into the detailed description, with each claim standing on its own as a separately claimed subject matter.

The claims are not intended to be limited to the aspects described herein, but are to be accorded the full scope consistent with the language claims and to encompass all legal equivalents. Notwithstanding, none of the claims are intended to embrace subject matter that fails to satisfy the requirements of the applicable patent law, nor should they be interpreted in such a way.

What is claimed is:

1. A computer-implemented method comprising:
determining, by a network switch, a prioritized set of state parameters for the network switch;
receiving, by the network switch, an indication of a command;
in response to receiving the indication of the command to be performed by the network switch, determining, by the network switch, whether the command is currently performable based at least in part on comparing a set of current state information of the network switch with the prioritized set of state parameters; and
in response to determining the command is not currently performable, re-determining, by the network switch at a specified future time, whether the command will be performable at the specified future time based at least in part on comparing the set of state information of the network switch at the specified future time with the prioritized state of state parameters.

2. The computer-implemented method of claim 1, wherein in response to determining the command is not currently performable, re-determining, by the network switch at a specified future time, whether the command will be performable at the specified future time further comprises:
in response to determining the command is not currently performable, sending, by the network switch to a network management system, a request to re-send the command at the specified future time;
in response to receiving an indication of the command that is re-sent by the network management system at the specified future time, determining, by the network switch, whether the command is performable at the specified future time based at least in part on comparing the set of state information of the network switch at the specified future time with the prioritized state of state parameters.

3. The computer-implemented method of claim 1, wherein the specified future time is a first specified future time that is a first specified time period after the determining of whether the command is currently performable, further comprising:
determining, by the network switch, that the command is not performable at the first specified future time; and
in response to determining that the command is not performable at the first time, re-determining, by the network switch at a second specified future time that is a second specified time period after the first specified future time, whether the command is performable at the second specified future time based at least in part on comparing the set of state information of the network switch at the second specified future time with the prioritized state of state parameters, wherein the second specified time period is at least double the first specified time period.

4. The computer-implemented method of claim 1, wherein:
the prioritized set of state parameters include a plurality of state parameters associated with a high priority, and one or more state parameters associated with a low priority; and
determining whether the command is currently performable based at least in part on comparing the set of current state information of the network switch with the prioritized set of state parameters further comprises determining the command is currently performable if the set of current state information does not meet the conditions of each of the plurality of state parameters associated with the high priority.

5. The computer-implemented method of claim 1, wherein:
the prioritized set of state parameters include a plurality of state parameters associated with a high priority, and one or more state parameters associated with a low priority; and
determining whether the command is currently performable based at least in part on comparing the set of current state information of the network switch with the prioritized set of state parameters further comprises determining the command is not currently performable if the set of current state information meets the conditions of one or more of the plurality of state parameters associated with the high priority.

6. The computer-implemented method of claim 1, wherein:
the prioritized set of state parameters include one or more state parameters associated with a high priority, and a plurality of state parameters associated with a low priority; and
determining whether the command is currently performable based at least in part on comparing the set of current state information of the network switch with the prioritized set of state parameters further comprises determining the command is currently performable if the set of current state information meets the conditions of one of the plurality of state parameters associated with the low priority evaluates and if the set of current state information does not meet the conditions any of remaining state parameters from the prioritized set of state parameters.

7. The computer-implemented method of claim 1, further comprising:
selecting, by the network switch and based at least in part on the command, the prioritized set of state parameters that is used to determine whether the command is currently performable out of a plurality of prioritized sets of state parameters.

8. The computer-implemented method of claim 1, wherein the command is a first command, further comprising:
receiving, by the network switch, an indication of a second command; and
in response to determining that the second command is received from an administrator of the network switch, performing, by the network switch, the second command.

9. The computer-implemented method of claim 1, wherein the command comprises one of: a reboot command, a configuration push, a control plane policing policy change, or a device profiling command.

10. The computer-implemented method of claim 1, wherein the prioritized set of state parameters includes one or more of: a first state parameter associated with a number of active clients at the network switch, a second state parameter associated with an amount of traffic at any one of network interfaces of the network switch, a third state parameter associated with one or more applications executing at the network switch, or a fourth state parameter associated with an open Secure Shell (SSH) sessions at the network switch.

11. A network switch comprising:
a memory comprising a prioritized set of state parameters for the network switch; and
a processor configured to execute instructions which, when executed, cause the processor to:
receive an indication of a command;
in response to receiving the indication of the command to be performed by the network switch, determine whether the command is currently performable based at least in part on comparing a set of current state information of the network switch with the prioritized set of state parameters; and
in response to determining the command is not currently performable, re-determine, at a specified future time, whether the command will be performable at the specified future time based at least in part on comparing the set of state information of the network switch at the specified future time with the prioritized state of state parameters.

12. The network switch of claim 11, wherein the processor that is configured to execute the instructions which, when executed, cause the processor to, in response to determining the command is not currently performable, re-determine, at a specified future time, whether the command will be performable at the specified future time is further configured to execute the instructions which, when executed, further cause the processor to:
in response to determining the command is not currently performable, send, to a network management system, a request to re-send the command at the specified future time;
in response to receiving an indication of the command that is re-sent by the network management system at the specified future time, determine whether the command is performable at the specified future time based at least in part on comparing the set of state information of the network switch at the specified future time with the prioritized state of state parameters.

13. The network switch of claim 11, wherein the specified future time is a first specified future time that is a first specified time period after the determining of whether the command is currently performable, and wherein the processor is further configured to execute the instructions which, when executed, further cause the processor to:
determine that the command is not performable at the first specified future time; and
in response to determining that the command is not performable at the first specified future time, re-determine, at a second specified future time that is a second specified time period after the first specified future time, whether the command is performable at the second specified future time based at least in part on comparing the set of state information of the network switch at the second specified future time with the prioritized state of state parameters, wherein the second specified time period is at least double the first specified time period.

14. The network switch of claim 11, wherein:
the prioritized set of state parameters include a plurality of state parameters associated with a high priority, and one or more state parameters associated with a low priority; and
the processor that is configured to execute the instructions which, when executed, cause the processor to determine whether the command is currently performable based at least in part on comparing the set of current state information of the network switch with the prioritized set of state parameters is further configured to execute the instructions which, when executed, further cause the processor to determine that the command is currently performable if the set of current state information does not meet the conditions of each of the plurality of state parameters associated with the high priority.

15. The network switch of claim 11, wherein:
the prioritized set of state parameters include a plurality of state parameters associated with a high priority, and one or more state parameters associated with a low priority; and
the processor that is configured to execute the instructions which, when executed, cause the processor to determine whether the command is currently performable based at least in part on comparing the set of current state information of the network switch with the prioritized set of state parameters is further configured to execute the instructions which, when executed, further cause the processor to determine that the command is not currently performable if the set of current state information meets the conditions of one or more of the plurality of state parameters associated with the high priority.

16. The network switch of claim 11, wherein:
the prioritized set of state parameters include one or more state parameters associated with a high priority, and a plurality of state parameters associated with a low priority; and
the processor that is configured to execute the instructions which, when executed, cause the processor to determine whether the command is currently performable based at least in part on comparing the set of current state information of the network switch with the prioritized set of state parameters is further configured to execute the instructions which, when executed, further cause the processor to determine that the command is currently performable if the set of current state information meets the conditions of one of the plurality of state parameters associated with the low priority evaluates and if the set of current state information does not meet the conditions of any of remaining state parameters from the prioritized set of state parameters.

17. The network switch of claim 11, wherein the command is a first command, and wherein the processor is further configured to execute the instructions which, when executed, further cause the processor to:
receive an indication of a second command; and
in response to determining that the second command is received from an administrator of the network switch, perform the second command.

18. The network switch of claim 11, wherein the command comprises one of: a reboot command, a configuration push, a control plane policing policy change, or a device profiling command.

19. The network switch of claim 11, wherein the prioritized set of state parameters includes one or more of: a first state parameter associated with a number of active clients at the network switch, a second state parameter associated with an amount of traffic at any one of network interfaces of the network switch, a third state parameter associated with one or more applications executing at the network switch, or a fourth state parameter associated with an open Secure Shell (SSH) sessions at the network switch.

20. A non-transitory machine-readable storage medium comprising machine-readable instructions for causing a processor at a network switch to execute a method, comprising:
determining a prioritized set of state parameters for the network switch;
receiving an indication of a command;
in response to receiving the indication of the command to be performed by the network switch, determining whether the command is currently performable based at least in part on comparing a set of current state information of the network switch with the prioritized set of state parameters; and
in response to determining the command is not currently performable, re-determining, at a specified future time, whether the command will be performable at the specified future time based at least in part on comparing the set of state information of the network switch at the specified future time with the prioritized state of state parameters.
